(19) United States
(12) Patent Application Publication
(10) Pub. No.: US 2025/0142480 A1
(43) Pub. Date: May 1, 2025

(54) METHODS AND APPARATUSES FOR UPLINK POWER CONTROL

(71) Applicant: Lenovo (Beijing) Limited, Beijing (CN)

(72) Inventors: Yu Zhang, Beijing (CN); Haipeng Lei, Beijing (CN)

(73) Assignee: Lenovo (Beijing) Limited, Beijing (CN)

(21) Appl. No.: 18/836,702

(22) PCT Filed: Feb. 9, 2022
(86) PCT No.: PCT/CN2022/075680

§ 371 Date: Aug. 7, 2024

(51) Int. Cl. H04W 52/14; H04W 72/1263

(52) U.S. Cl. CPC H04W 52/146; H04W 72/1263

(57) ABSTRACT

Disclosed are methods and apparatuses for uplink transmission power control. An embodiment of the subject application provides a user equipment (UE). The UE includes: a processor and a wireless transceiver coupled to the processor, wherein the processor is configured to: receive, with the wireless transceiver, a uplink (UL) grant scheduling at least one Physical Uplink Shared Channel (PUSCH) transmission occupying a first set of resource blocks (RBs) consisting of a first number of RBs; determine whether there is at least one RB of the first set of RBs belongs to a second set of RBs; select at least one power-control parameter set from at least two power-control parameter sets for each of the at least one PUSCH transmission based on the determination; and calculate one or more transmission powers for each of the at least one PUSCH transmission based on the at least one selected power-control parameter set.

### TECHNICAL FIELD

The present disclosure generally relates to wireless communication technologies, and especially to methods and apparatuses for uplink (UL) power control in a wireless communication network.

### BACKGROUND OF THE INVENTION

Time Division Duplexing (TDD) is widely used in wireless networks. When operating TDD in a wireless network, only one transmission direction, that is, downlink (DL) or UL is supported in a given time duration. However, allocation of a limited time duration for the UL transmissions would result in reduced coverage and increased latency. Therefore, it would be worth allowing the simultaneous existence of DL transmissions and UL transmissions in a given time duration, a.k.a. full duplex. More specifically, subband non-overlapping full duplex mode can be implemented in a wireless network, that is, the network can support simultaneous UL transmissions and DL transmissions occupying the non-overlapping subbands.

However, when operating subband non-overlapping full duplex mode, there may be mutual interference e.g., inter-subband cross-link interference (CLI) between some of the devices in the network. Thus, it is important for a network to manage the inter-subband CLI.

### SUMMARY

Various embodiments of the present disclosure provide solutions related to uplink (UL) power control for managing the inter-subband CLI when subband non-overlapping full duplex mode is implemented in a wireless network.

According to some embodiments of the present disclosure, a user equipment (UE) is provided. The UE may include a processor and a wireless transceiver coupled to the processor. The processor is configured to: receive, with the wireless transceiver, a UL grant scheduling at least one Physical Uplink Shared Channel (PUSCH) transmission occupying a first set of resource blocks (RBs) consisting of a first number of RBs; determine whether there is at least one RB of the first set of RBs belongs to a second set of RBs; select at least one power-control parameter set from at least two power-control parameter sets for each of the at least one PUSCH transmission based on the determination; and calculate one or more transmission powers for each of the at least one PUSCH transmission based on the at least one selected power-control parameter set.

In some embodiments, the processor is configured to, with the wireless transceiver, receive a higher layer signaling which indicates the at least two power-control parameter sets.

In some embodiments, the processor is further configured to perform the determination based on one or more indicators received in a higher layer signaling and/or the UL grant and/or a group common Physical Downlink Control Channel (GC-PDCCH).

In some embodiments, the processor is further configured to, with the wireless transceiver, receive a first indicator indicating that up to twice a second number of RBs in the first set of RBs belong to the second set of RBs.

In some embodiments, the first indicator is carried by the higher layer signaling.

In some embodiments, the first indicator is carried by the GC-PDCCH.

In some embodiments, the processor is further configured to receive, with the wireless transceiver, a second indicator indicating a UL/DL subband split pattern.

In some embodiments, the processor is further configured to receive, with the wireless transceiver, a third indicator.

In some embodiments, to perform the determination, the processor is further configured to: in response to that the third indicator is set to a first value, determine that none of the first set of RBs belongs to the second set of RBs; in response to that the third indicator is set to a second value, determine that the third number of RBs with the smallest indexes in the first set of RBs belong to the second set of RBs; in response to that the third indicator is set to the third value, determine that the third number of RBs with the largest indexes in the first set of RBs belong to the second set of RBs; or in response to that the third indicator is set to a fourth value, determine that the third number of RBs with the smallest indexes and the third number of RBs with the largest indexes in the first set of RBs belong to the second set of RBs.

In some embodiments, the at least two power-control parameter sets includes a first power-control parameter set and a second power-control parameter set.

In some embodiments, in response to that none of the first set of RBs belongs to the second set of RBs, to perform the selection and calculation, the processor is further configured to: select the first power-control parameter set; and calculate a first transmission power for each of the at least one PUSCH transmission or for each partial PUSCH transmission of the at least one PUSCH transmission based on the first power-control parameter set.

In some embodiments, in response to that there is at least one RB of the first set of RBs belongs to the second set of RBs, to perform the selection and calculation, the processor is further configured to: select at least the second power-control parameter set; and calculate a second transmission power for a PUSCH transmission or a partial PUSCH transmission of the at least one PUSCH transmission based on the second power-control parameter set, wherein the PUSCH transmission or the partial PUSCH transmission involves with the second set of RBs.

According to some embodiments of the present disclosure, a base station (BS) is provided. The BS may include a processor and a wireless transceiver coupled to the processor. The processor is configured to transmit, with the wireless transceiver, at least one of: a UL grant scheduling at least one PUSCH transmission occupying a first set of RBs consisting of a first number of RBs; a first indicator indicating that up to twice a second number of RBs in the first set of RBs belong to a second set of RBs; or a second indicator indicating a UL/DL subband split pattern via a GC-PDCCH.

In some embodiments, the processor is further configured to, with the wireless transceiver, transmit a higher layer signaling indicating the at least two power-control parameter sets.

In some embodiments, the first indicator carried by higher layer signaling.

In some embodiments, the first indicator is carried by the GC-PDCCH.

In some embodiments, the UL grant further includes a third indicator to assist a UE to determine which of the first set of RBs belongs to the second set of RBs.

In some embodiments, the at least two power-control parameter sets includes a first power-control parameter set and a second power-control parameter set.

According to some embodiments of the present disclosure, a method performed by a UE is provided. The method may include: receiving, with the wireless transceiver, a UL grant scheduling at least one PUSCH transmission occupying a first set of RBs consisting of a first number of RBs; determining whether there is at least one RB of the first set of RBs belongs to a second set of RBs; selecting at least one power-control parameter set from at least two power-control parameter sets for each of the at least one PUSCH transmission based on the determination; and calculating one or more transmission powers for each of the at least one PUSCH transmission based on the at least one selected power-control parameter set.

In some embodiments, the method may further include receiving a higher layer signaling which indicates the at least two power-control parameter sets.

In some embodiments, the determination is performed based on one or more indicators received in a higher layer signaling and/or the UL grant and/or GC-PDCCH.

In some embodiments, the method further includes receiving a first indicator indicating that up to twice a second number of RBs in the first set of RBs belong to the second set of RBs.

In some embodiments, the first indicator is carried by the higher layer signaling.

In some embodiments, the first indicator is carried by the GC-PDCCH.

In some embodiments, the method further includes receiving a second indicator indicating a UL/DL subband split pattern.

In some embodiments, the method further includes receiving a third indicator.

In some embodiments, the determination further includes: in response to that the third indicator is set to a first value, determining that none of the first set of RBs belongs to the second set of RBs; in response to that the third indicator is set to a second value, determining that a third number of RBs with the smallest indexes in the first set of RBs belong to the second set of RBs; in response to that the third indicator is set to the third value, determining that a third number of RBs with the largest indexes in the first set of RBs belong to the second set of RBs; or in response to that the third indicator is set to a fourth value, determining that a third number of RBs with the smallest indexes and a third number of RBs with the largest indexes in the first set of RBs belong to the second set of RBs.

In some embodiments, the at least two power-control parameter sets includes a first power-control parameter set and a second power-control parameter set.

In some embodiments, wherein in response to that none of the first set of RBs belongs to the second set of RBs, the selection and calculation further includes: selecting the first power-control parameter set; and calculating a first transmission power for each of the at least one PUSCH transmission or for each partial PUSCH transmission of the at least one PUSCH transmission based on the first power-control parameter set.

In some embodiments, in response to that there is at least one RB of the first set of RBs belongs to the second set of RBs, the selection and calculation further includes: selecting at least the second power-control parameter set; and calculating a second transmission power for a PUSCH transmission or a partial PUSCH transmission of the at least one PUSCH transmission based on the second power-control parameter set, wherein the PUSCH transmission or the partial PUSCH transmission involves with the second set of RBs.

According to some embodiments of the present disclosure, a method performed by a BS is provided. The method may include transmitting at least one of: a UL grant scheduling at least one PUSCH transmission occupying a first set of RBs consisting of a first number of RBs; a first indicator indicating that up to twice a second number of RBs in the first set of RBs belong to a second set of RBs; or a second indicator indicating a UL/DL subband split pattern via a GC-PDCCH.

In some embodiments, the method may further include transmitting a higher layer signaling indicating the at least two power-control parameter sets.

In some embodiments, the first indicator is carried by a higher layer signaling.

In some embodiments, the first indicator is carried by the GC-PDCCH.

In some embodiments, the UL grant further includes a third indicator to assist a UE to determine which of the first set of RBs belongs to the second set of RBs.

In some embodiments, the at least two power-control parameter sets includes a first power-control parameter set and a second power-control parameter set.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates an exemplary inter-subband CLI in a network;

FIG. 2 illustrates a flowchart of an exemplary method performed by a UE according to some embodiments of the present disclosure;

FIG. 3 illustrates an exemplary set of contiguous RBs occupied by at least one PUSCH transmission within a UL subband according to some embodiments of the present disclosure;

FIG. 4 illustrates an example about determination of a second set of RBs according to some embodiments of the present disclosure;

FIG. 5 illustrates an example about determination of a second set of RBs according to some embodiments of the present disclosure;

FIG. 6 illustrates an example about determination of a second set of RBs according to some embodiments of the present disclosure; and

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3rd generation partnership project (3GPP) long-term evolution (LTE) and LTE Advanced, 3GPP 5G new radio (NR), 5G-Advanced, 6G and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates an example of inter-subband CLI when operating subband non-overlapping full duplex mode in a wireless network.

Referring to FIG. 1, a wireless network 100 may include a UE 101, a UE 102 and a BS 103. Although a specific number of the UE 101, UE 102 and the BS 102 are depicted in FIG. 1, it is contemplated that any number of the UEs and the BSs may be included in the wireless network 100.

In some embodiments of the present disclosure, the UE 101 and UE 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE 101 and UE 102 may be referred to as a portable wireless communication device, a smart phone, a cellular telephone, a flip phone, a device having a subscriber identity module, a personal computer, a selective call receiver, or any other device that is capable of transmitting and receiving information. In some embodiments, the UE 101 or UE 102 may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, the BS 103 may be referred to as an access point, an access terminal, a base, a base unit, a macro cell, a Node B, an enhanced Node B, an evolved Node B, a next generation Node B (gNB), a Home Node B, a relay node, or a device, or described using other terminology used in the art. The BS 103 is generally a part of a radio access network that may include a controller communicably coupled to the BS 103.

The wireless network 100 may be compatible with any type of network that is capable of transmitting and receiving information. For example, the wireless network 100 is compatible with a cellular telephone network, a Time Division Multiple Access (TDMA)-based network, a Code Division Multiple Access (CDMA)-based network, an Orthogonal Frequency Division Multiple Access (OFDMA)-based network, a 3GPP-based network, a 3GPP LTE network, a 3GPP 5G NR network, a satellite communications network, a high altitude platform network, and/or other communications networks. More generally, however, the wireless network 100 may implement some other open or proprietary communication protocols, for example, IEEE 802.11 family, WiMAX, among other protocols.

For the wireless network 100, a resource grid of N_{subcarrier} subcarriers in frequency domain and N_{symbol} OFDM symbols in time domain is defined, and each element in the resource grid is called a resource element (RE), where N_{subcarrier} and N_{symbol} are both positive integers. A resource block (RB) is defined as 12 consecutive subcarriers in frequency domain. A subband is defined as a number of consecutive RBs in frequency domain.

For the wireless network 100, the UE 101 may receive a UL grant from the BS 103 scheduling at least one PUSCH transmission occupying a first set of RBs within a UL subband. A PUSCH corresponds to a set of REs carrying information originating from higher layers.

For the wireless network 100, subband non-overlapping full duplex mode may be supported, that is, there may be simultaneous UL transmission(s) 104 (e.g., PUSCH transmission(s)) from the UE 101 to the BS 103 and DL transmission(s) 105 from the BS 103 to the UE 102, and the UL transmission(s) 104 and the DL transmission(s) are transmitted within two non-overlapping adjacent subbands. When operating subband non-overlapping full duplex mode, the UL transmission(s) 104 transmitted from UE 101 may also arrive at UE 102, which may cause interference to the reception of the PDSCH transmission 105 at UE 102, so there may be inter-subband CLI 106 between the UE 101 and the UE 102.

The present disclosure provides solutions for mitigating the inter-subband CLI between UEs when operating subband non-overlapping full duplex mode.

According to some solutions of the present disclosure, if a PUSCH transmission is scheduled to be transmitted by a UE occupying several RBs within a UL subband, and the several RBs include one or more edge RBs, that is, the PUSCH transmission involves with the one or more edge RBs, the UE may determine a reduced transmission power for the PUSCH transmission so as to reduce the inter-subband CLI to other UEs. Edge RBs are a set of RBs which are located in the edge(s) of a UL subband and, the edge(s) of the UL subband is adjacent to a non-overlapping DL subband.

According to some other solutions of the present disclosure, if a PUSCH transmission is scheduled to be transmitted by a UE occupying several RBs within a UL subband, and the several RBs include one or more edge RBs, and if the UE can use more than one transmission powers for a single PUSCH transmission, the UE may determine a reduced transmission power for the partial PUSCH transmission involving with the one or more edge RBs and determine a normal transmission power for the partial PUSCH transmission not involving with the one or more edge RBs.

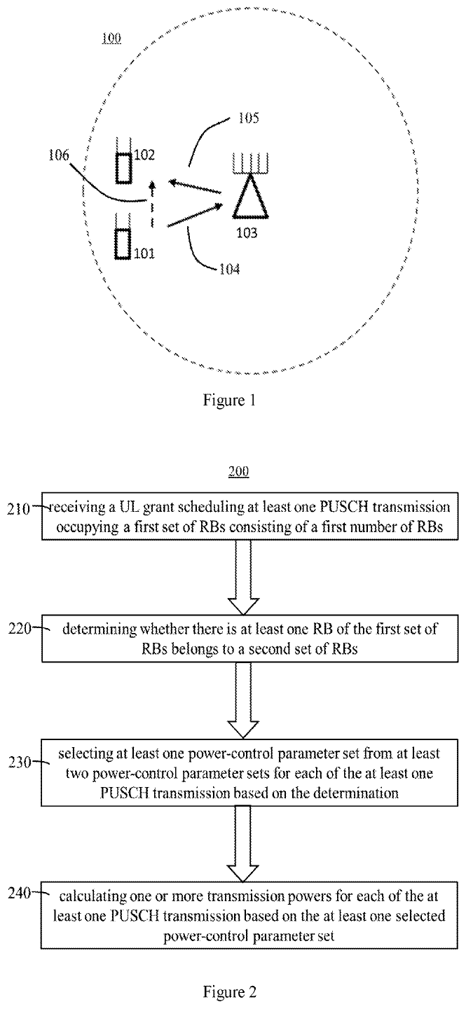

FIG. 2 illustrates a flowchart of an exemplary method 200 performed by a UE (e.g., UE 101) according to some embodiments of the present disclosure. Although method 200 is described herein with respect to a UE, it is contemplated that method 200 can be performed by other device with similar functionality.

In operation 210, the UE receives a UL grant from a BS (e.g., BS 103) scheduling at least one PUSCH transmission occupying a first set of RBs within a UL subband; herein the first set of RBs consists of a first number of RBs. In later description, the first number may be represented by N_{PUSCH} which is a positive integer. In some embodiments, the first set of RBs may be contiguous while in some other embodiments, the first set of RBs may be non-contiguous.

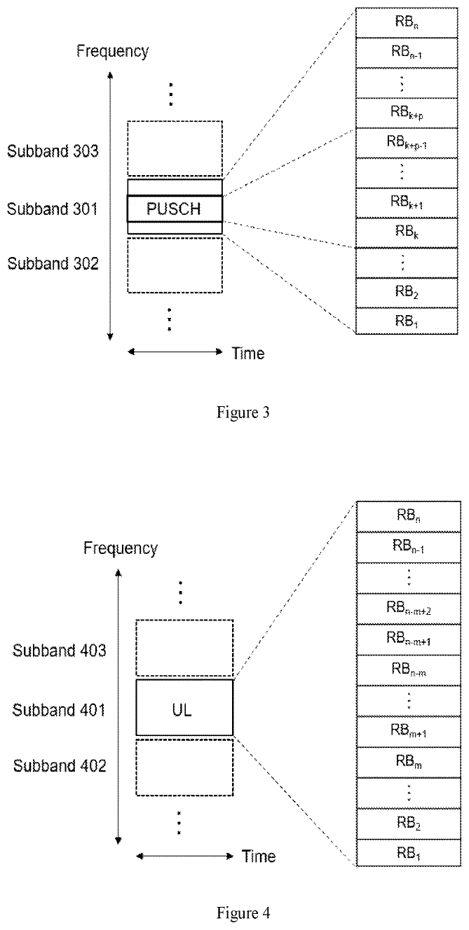

FIG. 3 illustrates an exemplary first set of contiguous RBs occupied by at least one PUSCH transmission within a UL subband 301; the first set of RBs consists of N_{PUSCH} RBs; herein N_{PUSCH} is a positive integer. The UL subband 301 consists of N_{subband} RBs; herein N_{subband} is also a positive integer and N_{subband}>=N_{PUSCH}, that is, the at least one PUSCH transmission may occupies all the RBs or a subset of RBs of the subband 301. In this example, the first set of RBs consists of N_{PUSCH}=p RBs (RBₖ, RBₖ₊₁ . . . RBₖ₊ₚ₋₁) and the subband 301 consists of N_{subband}=n RBs (RB₁, RB₂ . . . RBₙ), herein p, k, and n are positive integers. In the example shown in

FIG. 3, there may be a subband 302 and/or a subband 303 adjacent to the subband 301; and subband 302 is a UL subband or a DL subband, subband 303 is a UL subband or a DL subband.

In operation 220, the UE determines whether there is at least one RB of the first set of RBs belongs to a second set of RBs. The second set of RBs are edge RBs within the UL subband.

FIG. 4 illustrates an exemplary second set of RBs within a UL subband 401. If subband 402 is a DL subband and subband 403 is a UL subband, that is, the lower edge of the UL subband 401 is adjacent to a DL subband and upper edge of the UL subband 401 is adjacent to a UL subband, a second number (represented by N_{edge} in later description, which is a non-negative integer) of RBs, e.g., N_{edge}=m RBs (RB₁, RB₂ . . . RBₘ) located in the lower edge of the UL subband 401 can be deemed as edge RBs. In this case, the second set of RBs consists of m RBs. If both subband 402 and subband 403 are DL subbands, that is, the lower edge and the upper edge of the UL subband 401 are adjacent to DL subbands, m RBs (RB₁, RB₂ . . . RBₘ) located in the lower edge and m RBs (RBₙ₋ₘ₊₁, RBₙ₋ₘ₊₂ . . . RBₙ) located in the upper edge of the UL subband 401 can be deemed as edge RBs. In this case, the second set of RBs consist of 2m RBs.

In some embodiments, the UE may determine one or more transmission powers for a scheduled PUSCH transmission based on selecting at least one power-control parameter set and calculating the one or more transmission powers according to the selected at least one power-control parameter set.

In operation 230, the UE selects at least one power-control parameter set from at least two power-control parameter sets for each of the at least one PUSCH transmission based on the determination in operation 220. In some embodiments, the UE can at least determine power-control parameter P0 from the selected at least one power-control parameter set.

In some embodiments, the at least two power-control parameter sets are indicated by a higher layer signaling, e.g., RRC signaling, which is received by the UE before transmitting the at least one PUSCH transmission.

In some embodiments, the at least two power-control parameter sets at least include a first power-control parameter set and a second power-control parameter set.

In operation 240, the UE calculates one or more transmission powers for each of the at least one PUSCH transmission based on the at least one selected power-control parameter set.

In some embodiments, if the UE determines that none of the first set of RBs belongs to the second set of RBs, that is, none of the first set of RBs is an edge RB, the UE may select the first power-control parameter set for the at least one PUSCH transmission and calculate a first transmission power for each of the at least one PUSCH transmission based on the first power-control parameter set.

Referring to FIG. 4, in one embodiment, a UE receives a UL grant from a BS scheduling a PUSCH transmission occupying a first set of contiguous RBs within a UL subband 401; herein the first set of RBs consists of N_{PUSCH} RBs and the UL subband 401 consists of N_{subband} RBs. In this embodiment, N_{subband}=n.

In this embodiment, there is a DL subband 402 adjacent to a lower edge of the UL subband 401 and a UL subband 403 adjacent to a upper edge of the UL subband 401, so that a second set of RBs consisting of N_{edge}=m RBs (RB₁, RB₂ . . . RBₘ) located in the lower edge of the UL subband 401 can be deemed as edge RBs. Then the UE can determine whether there is at least one RB of the first set of RBs belongs to the second set of RBs. It should be noted that there may be multiple methods on how the UE perform the determination.

Before transmitting the PUSCH transmission, the UE is indicated at least two power-control parameter sets by a higher layer signaling, e.g., RRC signaling, which at least include a first power-control parameter set and a second power-control parameter set. The UE will calculate a normal transmission power used based on the first power-control parameter set while calculate a reduced transmission power based on the second power-control parameter set. The UE selects a power-control parameter set from the at least two power-control parameter sets for the PUSCH transmission based on the determination on whether there is at least one RB of the first set of RBs belongs to the second set of RBs. If the UE determines that there is at least one RB of the first set of RBs belongs to the second set of RBs, that is, there is at least one RB of the first set of RBs is an edge RB, the UE can select the second power-control parameter set and calculate a reduced transmission power used for the PUSCH transmission. If the UE determines that there is none of the first set of RBs belongs to the second set of RBs, that is, any of the first set of RBs is not an edge RB, the UE can select the first power-control parameter set and calculate a normal transmission power used for the PUSCH transmission.

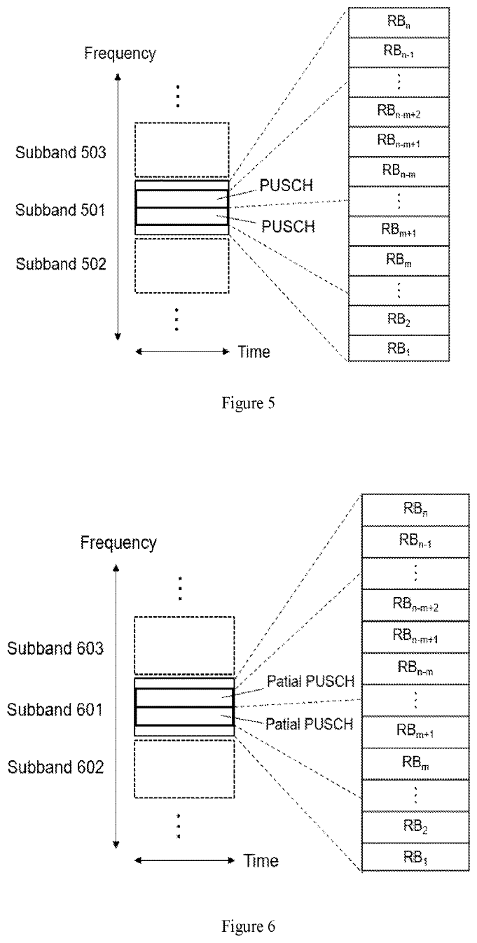

Referring to FIG. 5, in another embodiment, a UE receives a UL grant from a BS scheduling more than one PUSCH transmissions (e.g., two PUSCH transmissions as shown in FIG. 5) occupying a first set of contiguous RBs within a UL subband 501 in a Frequency-division multiplexing (FDM) manner; herein the first set of RBs consists of N_{PUSCH} RBs and the UL subband 501 consists of N_{subband} RBs. In this embodiment, N_{subband}=n. Each of the more than one PUSCH transmissions occupies a corresponding subset of the first set of RBs.

In the embodiment shown in FIG. 5, there is a DL subband 502 adjacent to a lower edge of UL subband 501 and a UL subband 503 adjacent to a upper edge of the UL subband 501, so that a second set of RBs consisting of N_{edge}=m RBs (RB₁, RB₂ . . . RBₘ) located in the lower edge of the UL subband 501 can be deemed as edge RBs. Then, the UE can determine whether there is at least one RB of the first set of RBs belongs to the second set of RBs. More specifically, in this embodiment, the UE can determine whether there is at least one RB of the corresponding subset of the first set of RBs occupied by each of the more than one PUSCH transmissions belongs to the second set of RBs. It should be noted that there may be multiple methods on how the UE perform the determination.

Before transmitting the more than one PUSCH transmissions, the UE is indicated at least two power-control parameter sets by a higher layer signaling, e.g., RRC signaling, which at least include a first power-control parameter set and a second power-control parameter set. The UE will calculate a normal transmission power based on the first power-control parameter set while calculate a reduced transmission power based on the second power-control parameter set. The UE selects a power-control parameter set from the at least two power-control parameter sets for each of the more than one PUSCH transmissions based on the determination on whether there is at least one RB of the first set of RBs belongs to the second set of RBs. For each of the more than one PUSCH transmissions, if the UE determines that there is at least one RB of the corresponding subset of the first set of RBs belongs to the second set of RBs, that is, the PUSCH transmission involves with the edge RBs, the UE can select the second power-control parameter set and calculate a reduced transmission power used for the PUSCH transmission. For each of the more than one PUSCH transmissions, if the UE determines that there is none of the corresponding subset of the first set of RBs belongs to the second set of RBs, that is, any RB of corresponding subset of the first set of RBs is not an edge RB, the UE can select the first power-control parameter set and calculate a normal transmission power used for the PUSCH transmission.

Referring to FIG. 6, in one further embodiment, a UE receives a UL grant from a BS scheduling a PUSCH transmission occupying a first set of contiguous RBs within a UL subband 601; herein the first set of RBs consists of N_{PUSCH} RBs and the UL subband 601 consists of N_{subband} RBs. In this embodiment, N_{subband}=n. In this embodiment, the UE can use more than one transmission powers for the PUSCH transmission, which consists of more than one partial PUSCH transmissions (e.g., two partial PUSCH transmissions as shown in FIG. 6). Each partial PUSCH transmission occupies a corresponding subset of the first set of RBs and can be transmitted with one of the more than one transmission powers. In this embodiment, there is a DL subband 602 adjacent to a upper edge of subband 601 and a UL subband 603 adjacent to a upper edge of the UL subband 601, so that a second set of RBs consisting of N_{edge}=m RBs (RB₁, RB₂ . . . RBₘ) located in the lower edge of the UL subband 601 can be deemed as edge RBs. After receiving the UL grant, the UE can determine whether there is at least one RB of the first set of RBs belongs to the second set of RBs. More specifically, in this embodiment, the UE can determine whether there is at least one RB of the corresponding subset of the first set of RBs occupied by each of the more than one partial PUSCH transmissions belongs to the second set of RBs. It should be noted that there may be multiple methods on how the UE perform the determination.

Before transmitting the more than one partial PUSCH transmissions, the UE is indicated at least two power-control parameter sets by a higher layer signaling, e.g., RRC signaling, which at least include a first power-control parameter set and a second power-control parameter set. The UE will calculate a normal transmission power based on the first power-control parameter set while calculate a reduced transmission power based on the second power-control parameter set. The UE selects a power-control parameter set from the at least two power-control parameter sets for each of the more than one partial PUSCH transmissions based on the determination on whether there is at least one RB of the first set of RBs belongs to the second set of RBs. For each of the more than one partial PUSCH transmissions, if the UE determines that there is at least one RB of the corresponding subset of the first set of RBs belongs to the second set of RBs, that is, the partial PUSCH transmission involves with the edge RBs, the UE can select the second power-control parameter set and calculate a reduced transmission power used for the partial PUSCH transmission. For each of the more than one partial PUSCH transmissions, if the UE determines that any RB of the corresponding subset of the first set of RBs doesn't belong to the second set of RBs, that is, the partial PUSCH transmission doesn't involve with the edge RBs, the UE can select the first power-control parameter set and calculate a normal transmission power used for the partial PUSCH transmission.

It can be seen that the determination in operation 220 whether there is at least one RB of the first set of RBs belongs to a second set of RBs is necessary.

According to some embodiments of the present disclosure, in operation 220, the UE can perform the determination on whether there is at least one RB of the first set of RBs belongs to the second set of RBs, that is, whether there is at least one RB of the first set of RBs is an edge RB based on one or more indicators received in the higher layer signaling and/or the UL grant and/or a GC-PDCCH.

In some embodiments, a UE receives a UL grant from the BS scheduling at least one PUSCH transmission occupying a first set of RBs within a UL subband and the UE may receive a Reduced Transmission Power Indicator (RTPI) in the UL grant indicating which power-control parameter set should be used for each of the at least one PUSCH transmissions. In other words, by receiving the RTPI in the UL grant, the UE can determine whether there is at least one RB of the first set of RBs is an edge RB.

In one embodiment, a UE receives a UL grant from a BS scheduling a PUSCH transmission occupying a first set of RB within a UL subband. A RTPI in the UL grant may indicate that a first power-control parameter set should be used for calculating the transmission power used for the PUSCH transmission, for example, the RTPI is set to a first value, in other words, the RTPI in the UL grant indicates that none of the first set of RBs is an edge RB. The RTPI in the UL grant may indicate that a second power-control parameter set should be used for calculating the transmission power used for the PUSCH transmission, for example, the RTPI is set to a second value, in other words, the RTPI in the UL grant indicates that there is at least one RB of the first set of RBs is an edge RB.

In another embodiment, a UE receives a UL grant from a BS scheduling two PUSCH transmissions occupying a first set of RB within a UL subband in a FDM manner. A RTPI in the UL grant may indicate that a first power-control parameter set should be used for calculating the transmission powers used for both of the PUSCH transmissions, for example, the RTPI is set to a first value. The RTPI in the UL grant may indicate that a second power-control parameter set should be used for calculating the transmission powers used for both of the PUSCH transmissions, for example, the RTPI is set to a second value. The RTPI in the UL grant may indicate that a first power-control parameter set should be used for calculating the transmission powers used for one of the PUSCH transmissions and a second power-control parameter set should be used for calculating the transmission powers used for the other PUSCH transmission, for example, the RTPI is set to a third value or a fourth value.

In some embodiments, a UE may receive a Subband Pattern Indicator (SPI) indicating a UL/DL subband split pattern of a given frequency band for a given time duration. The SPI is carried by a GC-PDCCH. After receiving the SPI, the UE can determine a subband of a given frequency band is a UL subband or a DL subband for a given time duration.

For example, referring back to FIG. 4, after receiving the SPI in a slot, the UE can determine whether Subband 401 is a UL subband or a DL subband in a next slot, whether Subband 402 is a UL subband or a DL subband in a next slot, and whether Subband 403 is a UL subband or a DL subband in a next slot.

In some embodiments, a UE may receive an Edge RB Number Indicator (ERBNI) indicating that up to twice a second number (represented by N_{edge} in later description, which is a non-negative integer) of RBs in the first set of RBs belong to the second set of RBs, that is, up to 2 N_{edge} RBs in the first set of RBs are edge RBs. The ERBNI may be carried by a higher layer signaling or a GC-PDCCH. For example, referring back to FIG. 4, after receiving the ERBNI which is set to a value ‘m’, the UE can determine that m RBs (RB₁, RB₂ . . . RBₘ) located in the lower edge of the UL subband 401 are edge RBs if Subband 401 and 402 are UL subbands while Subband 403 is a DL subband. In this example, the edge RBs within the Subband 401 are of m RBs. In another example, the UE can determine m RBs (RB₁, RB₂ . . . RBₘ) located in the lower edge of the UL subband 401 and m RBs (RBₙ₋ₘ₊₁, RBₙ₋ₘ₊₁ . . . RBₙ) located in the upper edge of the UL subband 401 are edge RBs if Subband 401 is a UL subband while both Subband 402 and 403 are DL subbands. In this example, the edge RBs within the Subband 401 consist of 2m RBs.

In some embodiments, a UE receives a UL grant from a BS scheduling at least one PUSCH transmission occupying a first set of RB within a UL subband and the UE may receive an Edge RB Location Indicator (ERBLI) in the UL grant indicating whether there is at least one RB of the first set of RBs is an edge RB and if there is, the edge RB(s) is/are located in the upper edge or lower edge or both edges of the first set of RBs. For example, after receiving the ERBLI which is set to a value ‘00’, the UE can determine that any of the first set of RBs is not an edge RB. If the ERBLI is set to a value ‘01’, the UE can determine that a third number (represented by N_{edge} in later description, which is a non-negative integer) of edge RBs are located in the upper edge of the first set of RBs, that is, N_{edge} RB with the largest indexes in the first set of RBs are edge RBs. If the ERBLI is set to a value ‘10’, the UE can determine that N_{edge} edge RBs are located in the lower edge of the first set of RBs, that is, N_{edge} RB with the smallest indexes in the first set of RBs are edge RBs. If the ERBLI is set to a value ‘11’, the UE can determine that N_{edge} edge RBs are located in the upper edge of the first set of RBs and N_{edge} edge RBs are located in the lower edge of the first set of RBs, that is, N_{edge} RB with the smallest indexes and N_{edge} RB with the largest indexes in the first set of RBs are edge RBs. In some embodiments, N_{edge} can also be indicated by the UL grant. In some other embodiments, an ERBNI which is set to a value ‘m’ carried by a higher layer signaling or a GC-PDCCH may also be received by the UE, then the UE can determine that N_{edge}=m.

In some embodiments, a UE receives a UL grant from a BS scheduling at least one PUSCH transmission occupying a first set of RB within a UL grant and the UE determines a third set of RBs that belong to a first set of RBs and also belong to a second set of RBs. The second RBs are edge RBs within the UL subband. The UE may use a zero-power for the partial PUSCH transmission occupying the third set of RBs based on puncture and rate-matching.

It would be contemplated that the BS may perform methods corresponding to the aforementioned methods performed by a UE.

According to some embodiments of the present disclosure, the BS transmits at least one of: a UL grant scheduling at least one PUSCH transmission from a UE occupying a first set of RBs consisting of a first number of RBs within a UL subband; a first indicator (i.e., ERBNI) indicating that up to twice a second number of RBs in the first set of RBs belong to a second set of RBs; or a second indicator (i.e., SPI) indicating a UL/downlink (DL) subband split pattern via a GC-PDCCH. The second set of RBs are edge RBs within the UL subband.

In some embodiments, the BS transmits a higher layer signaling indicating at least two power-control parameter sets. In some embodiments, the at least two power-control parameter sets includes a first power-control parameter set and a second power-control parameter set.

In some embodiments, the ERBNI is carried by the higher layer signaling. In some other embodiments, the ERBNI is carried by the GC-PDCCH.

In some embodiments, the UL grant further includes a third indicator (i.e., an ERBLI) indicating whether there is at least one RB of the first set of RBs is an edge RB and if there is, the edge RB(s) is/are located in the upper edge or lower edge or both edges of the first set of RBs. In other words, the third indicator may assist the UE to determine which of the first set of RBs belongs to the second set of RBs.

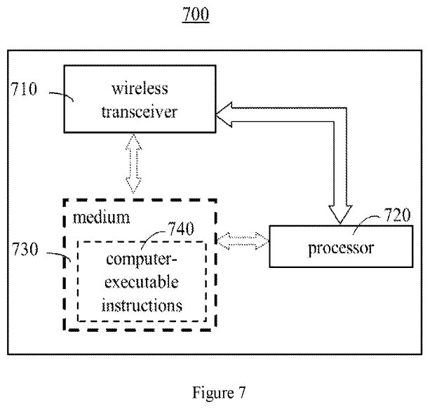

FIG. 7 illustrates a simplified block diagram of an exemplary apparatus 700 according to various embodiments of the present disclosure.

In some embodiments, apparatus 700 may be or include at least a part of a UE or similar device that can use the technology of the present disclosure.

In some embodiments, apparatus 700 may be or include at least a part of a BS or similar device that can use the technology of the present disclosure.

As shown in FIG. 7, apparatus 700 may include at least wireless transceiver 710 and processor 720, wherein wireless transceiver 710 may be coupled to processor 720. Furthermore, apparatus 700 may include non-transitory computer-readable medium 730 with computer-executable instructions 740 stored thereon, wherein non-transitory computer-readable medium 730 may be coupled to processor 720, and computer-executable instructions 740 may be configured to be executable by processor 720. In some embodiments, wireless transceiver 710, non-transitory computer-readable medium 730, and processor 720 may be coupled to each other via one or more local buses.

Although in FIG. 7, elements such as wireless transceiver 710, non-transitory computer-readable medium 730, and processor 720 are described in the singular, the plural is contemplated unless limitation to the singular is explicitly stated. In certain embodiments of the present disclosure, the apparatus 700 may further include other components for actual usage.

In some embodiments, the apparatus 700 is a UE or at least a part of a UE. Processor 720 is configured to cause the apparatus 700 at least to perform, with wireless transceiver 710, any method described above which is performed by a UE according to the present disclosure.

In some embodiments, processor 720 is configured to: receive, with wireless transceiver 710, a UL grant scheduling at least one PUSCH transmission occupying a first set of RBs consisting of a first number of RBs within a UL subband; determine whether there is at least one RB of the first set of RBs belongs to a second set of RBs; select at least one power-control parameter set from at least two power-control parameter sets for each of the at least one PUSCH transmission based on the determination; and calculate one or more transmission powers for each of the at least one PUSCH transmission based on the at least one selected power-control parameter set. The second set of RBs are edge RBs within the UL subband.

In some embodiments, processor 720 is configured to receive, with wireless transceiver 710, receive a higher layer signaling (e.g., radio resource control (RRC)) which indicates the at least two power-control parameter sets.

In some embodiments, processor 720 is further configured to determine whether there is at least one RB of the first set of RBs belongs to a second set of RBs based on one or more indicators received in the higher layer signaling and/or the UL grant and/or a GC-PDCCH.

In some embodiments, processor 720 is further configured to, with wireless transceiver 710, receive a first indicator (i.e., an ERBNI) indicating that up to twice a second number of RBs in the first set of RBs belong to the second set of RBs. For example, the second number is set to a non-negative integer ‘m’, the UE may determine that up to 2m edge RBs of the first set of RBs belong to the second set of RBs. In some embodiments, the first indicator is carried by the higher layer signaling. In some embodiments, the first indicator is carried by the GC-PDCCH.

In some embodiments, processor 720 is further configured to receive, with wireless transceiver 710, a second indicator (i.e., an SPI) indicating a UL/DL subband split pattern of a given frequency band for a given time duration. In some embodiments, the SPI is carried by the GC-PDCCH. After receiving the SPI, the UE can determine a subband of a given frequency band is a UL subband or a DL subband for a given time duration.

In some embodiments, processor 720 is further configured to receive, with wireless transceiver 710, a third indicator (i.e., an ERBLI) in the UL grant; herein the third indicator indicates whether there is at least one RB of the first set of RBs is an edge RB and if there is, the edge RB(s) is/are located in the upper edge or lower edge or both edges of the first set of RBs. For example, after receiving the ERBLI which is set to a value ‘00’, the UE can determine that any of the first set of RBs is not an edge RB. If the ERBLI is set to a value ‘01’, the UE can determine that p (i.e., a third number) edge RBs are located in the upper edge of the first set of RBs, that is, p RBs with the largest indexes in the first set of RBs belong to the second set of RBs. If the ERBLI is set to a value ‘10’, the UE can determine that p edge RBs are located in the lower edge of the first set of RBs, that is, p RBs with the smallest indexes in the first set of RBs belong to the second set of RBs. If the ERBLI is set to a value ‘11’, the UE can determine that p edge RBs are located in the upper edge of the first set of RBs and p edge RBs are located in the lower edge of the first set of RBs, that is, p RBs with the smallest indexes and p RBs with the largest indexes in the first set of RBs belong to the second set of RBs. Herein p is a non-negative integer and can be indicated by the UL grant or an indicator carried by a higher layer signaling or a GC-PDCCH.

In some embodiments, the at least two power-control parameter sets includes a first power-control parameter set and a second power-control parameter set. In some embodiments, the first power-control parameter set is for normal-power PUSCH transmission, and the second power-control parameter set is for reduced-power PUSCH transmission.

In some embodiments, the UL grant schedules a PUSCH transmission occupying the first set of RBs, that is, the at least one PUSCH transmission only includes the PUSCH transmission; if none of the first set of RBs belongs to the second set of RBs, processor 720 is configured to: select the first power-control parameter set; and calculate a first transmission power for the PUSCH transmission based on the first power-control parameter set.

In some embodiments, the UL grant schedules more than one PUSCH transmissions occupying the first set of RBs in a FDM manner, that is, the at least one PUSCH transmission includes the more than one PUSCH transmissions, and each of the more than one PUSCH transmissions occupies a corresponding subset of the first set of RBs; if none of the first set of RBs belongs to the second set of RBs, processor 720 is configured to: select the first power-control parameter set; and calculate a first transmission power for each of the more than one PUSCH transmissions based on the first power-control parameter set.

In some embodiments, the UL grant schedules a single PUSCH transmission which consists of more than one partial PUSCH transmissions, and each partial PUSCH transmission occupies a corresponding subset of the first set of RBs and can be transmitted with a transmission power; if none of the first set of RBs belongs to the second set of RBs, processor 720 is configured to: select the first power-control parameter set; and calculate a first transmission power for each of the more than one partial PUSCH transmissions based on the first power-control parameter set.

In some embodiments, the UL grant schedules a PUSCH transmission occupying the first set of RBs, that is, the at least one PUSCH transmission only includes the PUSCH transmission; if at least one of the first set of RBs belongs to the second set of RBs, processor 720 is configured to: select the second power-control parameter set; and calculate a second transmission power for the PUSCH transmission based on the second power-control parameter set.

In some embodiments, the UL grant schedules more than one PUSCH transmissions occupying the first set of RBs in a FDM manner, that is, the at least one PUSCH transmission includes the more than one PUSCH transmissions, and each of the more than one PUSCH transmissions occupies a corresponding subset of the first set of RBs; for a PUSCH transmission of the more than one PUSCH transmissions, if there is at least one of the corresponding subset of the first set of RBs belongs to the second set of RBs (means that there is at least one RB of the first set of RBs belongs to the second set of RBs), that is, the PUSCH transmission involves with the second set of RBs, processor 720 is configured to: select the second power-control parameter set; and calculate a second transmission power for the PUSCH transmission based on the first power-control parameter set.

In some embodiments, the UL grant schedules a single PUSCH transmission which consists of more than one partial PUSCH transmissions and each partial PUSCH transmission occupies a corresponding subset of the first set of RBs and can be transmitted with a transmission power; for a partial PUSCH transmission of the more than one partial PUSCH transmissions, if there is at least one RB of the corresponding subset of the first set of RBs belongs to the second set of RBs (means that there is at least one RB of the first set of RBs belongs to the second set of RBs), that is, the partial PUSCH transmission involves with the second set of RBs, processor 720 is configured to: select the second power-control parameter set; and calculate a second transmission power for the partial PUSCH transmission based on the second power-control parameter set.

In some embodiments, the apparatus 700 is a BS or at least a part of a BS. Processor 720 is configured to cause the apparatus 700 at least to perform, with wireless transceiver 710, any method described above which is performed by a BS according to the present disclosure.

According to some embodiments of the present disclosure, the apparatus 700 transmits, with the wireless transceiver 710, at least one of: a UL grant scheduling at least one PUSCH transmission from a UE occupying a first set of RBs consisting of a first number of RBs within a UL subband; a first indicator (i.e., ERBNI) indicating that up to twice a second number of RBs in the first set of RBs belong to a second set of RBs; or a second indicator (i.e., SPI) indicating a UL/DL subband split pattern of a given frequency band for a given time duration via a GC-PDCCH. The second set of RBs are edge RBs within the UL subband.

In some embodiments, the apparatus 700 transmits, with the wireless transceiver 710, a higher layer signaling indicating at least two power-control parameter sets via a higher layer signaling. In some embodiments, the at least two power-control parameter sets includes a first power-control parameter set and a second power-control parameter set.

In some embodiments, the ERBNI is carried by the higher layer signaling. In some embodiments, the ERBNI is carried by the GC-PDCCH.

In some embodiments, the UL grant further includes a third indicator (i.e., an ERBLI) in the UL grant indicating whether there is at least one RB of the first set of RBs is an edge RB and if there is, the edge RB(s) is/are located in the upper edge or lower edge or both edges of the first set of RBs. According to some embodiments of the present disclosure, the ERBLI may assist a UE to determine which of the first set of RBs belongs to the second set of RBs.

In various example embodiments, processor 720 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 720 may also include at least one other circuitry or element not shown in FIG. 9.

In various example embodiments, non-transitory computer-readable medium 730 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 730 may include, but is not limited to, an electric, a magnetic, an optical, an electromagnetic, an infrared, or a semiconductor system, apparatus, or device or any combination of the above.

Further, in various example embodiments, exemplary apparatus 800 may also include at least one other circuitry, element, and interface, for example antenna element, and the like.

In various example embodiments, the circuitries, parts, elements, and interfaces in exemplary apparatus 800, including processor 720 and non-transitory computer-readable medium 730, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive an uplink (UL) grant scheduling at least one physical uplink shared channel (PUSCH) transmission occupying a first set of resource blocks (RBs) consisting of a first number of RBs;
determine whether there is at least one RB of the first set of RBs that belongs to a second set of RBs;
select at least one power-control parameter set from at least two power-control parameter sets for each of the at least one PUSCH transmission based at least in part on the determination; and
calculate one or more transmission powers for each of the at least one PUSCH transmission based at least in part on the at least one selected power-control parameter set.

2. The UE of claim 1, wherein the at least one processor is further configured to cause the UE to receive a higher layer signaling which indicates the at least two power-control parameter sets.

3. The UE of claim 1, wherein the at least one processor is further configured to cause the UE to perform the determination based at least in part on one or more indicators received in at least one of a higher layer signaling, the UL grant, or a group common physical downlink control channel (GC-PDCCH).

4. The UE of claim 3, wherein the at least one processor is further configured to cause the UE to receive a first indicator indicating that up to twice a second number of RBs in the first set of RBs belong to the second set of RBs.

5. The UE of claim 4, wherein the first indicator is carried by the higher layer signaling.

6. The UE of claim 4, wherein the first indicator is carried by the GC-PDCCH.

7. The UE of claim 3, wherein the at least one processor is further configured to cause the UE to receive a second indicator indicating a UL/DL subband split pattern.

8. The UE of claim 3, wherein the at least one processor is further configured to cause the UE to receive a third indicator.

9. The UE of claim 8, wherein to perform the determination, the at least one processor is further configured to cause the UE to:
in response to the third indicator having a first value, determine that none of the first set of RBs belong to the second set of RBs;
in response to the third indicator having a second value, determine that a third number of RBs with smallest indexes in the first set of RBs belong to the second set of RBs;
in response to the third indicator having a third value, determine that a third number of RBs with largest indexes in the first set of RBs belong to the second set of RBs; or
in response to the third indicator having a fourth value, determine that the third number of RBs with the smallest indexes and the third number of RBs with the largest indexes in the first set of RBs belong to the second set of RBs.

10. The UE of claim 1, wherein the at least two power-control parameter sets includes a first power-control parameter set and a second power-control parameter set.

11. The UE of claim 10, wherein in response to none of the first set of RBs belonging to the second set of RBs, to perform the selection and calculation, the at least one processor is further configured to cause the UE to:
select the first power-control parameter set; and
calculate a first transmission power for each of the at least one PUSCH transmission or for each partial PUSCH transmission of the at least one PUSCH transmission based at least in part on the first power-control parameter set.

12. The UE of claim 10, wherein in response to at least one RB of the first set of RBs belonging to the second set of RBs, to perform the selection and calculation, the at least one processor is further configured to cause the UE to:
select at least the second power-control parameter set; and
calculate a second transmission power for a PUSCH transmission or a partial PUSCH transmission of the at least one PUSCH transmission based at least in part on the second power-control parameter set, wherein the PUSCH transmission or the partial PUSCH transmission involves the second set of RBs.

13. A base station for wireless communication, comprising:
at least one memory; and
at least one processor coupled with the at least one memory and configured to cause the base station to transmit at least one of:
an uplink (UL) grant scheduling at least one physical uplink shared channel (PUSCH) transmission from a user equipment (UE) occupying a first set of resource blocks (RBs) consisting of a first number of RBs;
a first indicator indicating that up to twice a second number of RBs in the first set of RBs belong to a second set of RBs; or
a second indicator indicating a UL/downlink (DL) subband split pattern via a group common physical downlink control channel (GC-PDCCH).

14. The base station of claim 13, wherein the at least one processor is further configured to cause the base station to transmit a higher layer signaling indicating at least two power-control parameter sets for each of the at least one PUSCH transmission.

15. The base station of claim 13, wherein the UL grant further includes a third indicator to assist the UE to determine which of the first set of RBs belongs to the second set of RBs.

16. A processor for wireless communication, comprising:
at least one controller coupled with at least one memory and configured to cause the processor to:
receive an uplink (UL) grant scheduling at least one physical uplink shared channel (PUSCH) transmission occupying a first set of resource blocks (RBs) consisting of a first number of RBs;
determine whether there is at least one RB of the first set of RBs that belongs to a second set of RBs;
select at least one power-control parameter set from at least two power-control parameter sets for each of the at least one PUSCH transmission based at least in part on the determination; and
calculate one or more transmission powers for each of the at least one PUSCH transmission based at least in part on the at least one selected power-control parameter set.

17. The processor of claim 16, wherein the at least one controller is further configured to cause the processor to receive a higher layer signaling which indicates the at least two power-control parameter sets.

18. The processor of claim 16, wherein the at least one controller is further configured to cause the processor to perform the determination based at least in part on one or more indicators received in at least one of a higher layer signaling, the UL grant, or a group common physical downlink control channel (GC-PDCCH).

19. The processor of claim 18, wherein the at least one controller is further configured to cause the processor to receive a first indicator indicating that up to twice a second number of RBs in the first set of RBs belong to the second set of RBs.

20. A method performed by a user equipment (UE), the method comprising:
receiving an uplink (UL) grant scheduling at least one physical uplink shared channel (PUSCH) transmission occupying a first set of resource blocks (RBs) consisting of a first number of RBs;
determining whether there is at least one RB of the first set of RBs that belongs to a second set of RBs;
selecting at least one power-control parameter set from at least two power-control parameter sets for each of the at least one PUSCH transmission based at least in part on the determination; and
calculating one or more transmission powers for each of the at least one PUSCH transmission based at least in part on the at least one selected power-control parameter set.
